(19) United States
(12) Patent Application Publication
(10) Pub. No.: US 2007/0159542 A1
(43) Pub. Date: Jul. 12, 2007

(54) COLOR FILTER ARRAY WITH NEUTRAL ELEMENTS AND COLOR IMAGE FORMATION

(76) Inventor: Gang LUO, East Boston, MA (US)

Correspondence Address: GANG LUO, 8-B TRUSEMAN TERRACE, EAST BOSTON, MA, 02128, US

(21) Appl. No.: 11/616,840

(22) Filed: Dec. 27, 2006

Related U.S. Application Data
(60) Provisional application No. 60/758,361, filed on Jan. 12, 2006.

(51) Int. Cl. H04N 9/04

(52) U.S. Cl. 348/272

(57) ABSTRACT

The invention is directed to a method and a device for providing higher performance imaging capture using a novel pattern of a color filter array that enables one to achieve higher sampling rate for luminance than for chrominance. A majority of the elements in the CFA are neutral elements. Gray scale images with high spatial resolution and high light sensitivity can be acquired from image samplings at these neutral elements. The remaining elements of the CFA are color filtered ones. Color elements cluster to form a repeating block pattern. Color images with low spatial resolution but low color artifacts can be acquired from image samplings at these color filter elements. The color images are transformed into a luminance-chrominance color space, and the luminance components are replaced with the gray scale images to regain high spatial resolution.

### CROSS-RELATED APPLICATION

Under 35 U.S.C. 119(e)1), this application claims the benefit of provisional application serial number, 60/758,361, filed Jan. 12, 2006, entitled, “Color filter array with neutral elements and color image formation.”

### FIELD OF INVENTION

The invention relates generally to the field of electronic photography, and in particular to electronic imaging apparatus having a single imaging sensor and a color filter array.

### BACKGROUND OF INVENTION

A color filter array (CFA) is a required component in single-chip color imaging devices. Its pattern, consisting of color filter elements, allows “color-blind” sensors such as Charge Coupled Devices (CCD), complimentary metal oxide semiconductor (CMOS) and charge-injection device (CID) sensors to capture vivid full-color images. The most commonly adopted CFA pattern is the Bayer pattern as cited in U.S. Pat. No. 3,971,065 and incorporated herein by reference, which consists of 50% of green elements and 25% of elements for red and blue respectively.

In Bayer's patent, the CFA was initially claimed to be comprised of one type of luminance element (Y), and two types of chrominance elements (C1 and C2). Such a pattern was employed based on the recognition of human visual system's relatively greater ability to discern luminance detail. However, as the exact chrominance filters as required by Bayer have not yet been invented, green filters are commonly used to substitute for Y, red and blue filters for C1 and C2 respectively.

Some other patents (U.S. Pat. Nos. 4,663,661, 5,374,956, 6,917,381) have proposed CFA with more than 50% of green elements, attempting to achieve higher resolution in luminance. However, the green component is not exactly the same as the luminance component. For reddish and bluish scenes, the luminance estimation based only upon green elements would be far from the true value. In these cases, special CFAs may be favorable. For instance, a CFA comprising 50% red elements has been proposed for applications of imaging internal human body organs (U.S. Pat. No. 6,783,900 B2), as these images are usually reddish.

Previous patents such as U.S. Pat. Nos. 5,323,233, 5,914,749, 6,476,865B1 and 6,714,243B1 disclosed CFA patterns wherein partial elements have no spectral selectivity to directly detect luminance. In patents U.S. Pat. Nos. 6,476,865B1, and 6,714,243B1, 25% of elements are neutral. In patents U.S. Pat. Nos. 5,323,233 and 5,914,749 incorporated herein by reference, the proportion of luminance elements is as high as 50%.

However, the 50% sampling rate of luminance is not necessarily the optimal design for a human visual system. In image files saved in JPEG format, the most popular image format at present, more than 50% of data bits are for luminance. For example, the average amount of luminance data in high quality JPEG images is about 72%, and the number in low quality JPEG images is about 85% (G. Luo, “A novel color filter array with 75% transparent elements” Proceedings SPIE Vol. 6502, (Jan. 29, 2007), Appendix. In press). In other words, about 28% or 15% of data are of chrominance. The quality of JPEG images is not obviously attenuated when so little data bits are used for chrominance. There is a need therefore for a CFA pattern that may better match human visual system, popular image formats as well as address color artifacts that sparsely chrominance sampling may cause.

### SUMMARY OF THE INVENTION

The present invention is directed to a method and a device for providing higher performances of image capturing and rendering than conventional methods and devices.

An object of the present invention is to provide CFA patterns that can achieve higher sampling rate for luminance than for chrominance. A majority of the CFA's are neutral elements without color selectivity. These elements can be neutral density filters, which only reduce the intensity of light, or completely transparent, which do not cause light energy loss. Gray scale images with high spatial resolution and high light sensitivity can be acquired from image samplings at these neutral elements.

Another object of the invention is to provide CFA patterns that can yield low color artifacts in output images in spite of sparse sampling of chrominance. The remaining elements of the CFA other than neutral elements are color filtered ones. Color elements cluster to form a repeating block pattern, and each block includes several types of color filter elements that are necessary for calculation of at least one color pixel. Color images with low spatial resolution but low color artifacts can be acquired from image samplings at these color filter elements.

A further object of the invention is to provide a color image formation method to combine luminance and chrominance information. The gray scale images and the color images mentioned above are combined to form output images in a luminance-chrominance color space, such as CIE Lab or HSB (hue-saturation-brightness). The process is to first transform the color images to one of the luminance-chrominance color spaces, e.g. Lab, and then to replace the luminance component (e.g. L component in the Lab model) with the gray scale images acquired from neutral elements.

Another object of the invention is to provide a color image capturing apparatus comprising CFA means, in which a majority of the elements in the CFA are neutral elements without color selectivity, and the remaining elements of the CFA color filtered ones clustering to form a repeating block pattern.

A still further object of the invention is to provide a color image capturing apparatus comprising image formation means, in which the processing of gray scale images and color images is firstly separated, and then they are combined in a luminance-chrominance color space by replacing the luminance components of the color images with the gray-scale images.

Preferred methods include application of interpolation schemes and algorithms to transform data into useful formats for subsequent processing, storage, transmission and rendering.

Preferred devices include CCD, CID and CMOS image sensor arrays that have a filter grid layered over sensing elements and integrated electronic elements for reading and processing information captured by the sensors.

### BRIEF DESCRIPTION OF DRAWINGS

FIG. 1. The Bayer pattern, a prior art description of a CFA.

FIG. 2. One CFA embodiment of the present invention, in which 75% of elements are neutral (shown as blank cells).

FIG. 3. Schematic illustration that describes the process of the image formation to combine luminance and chrominance information.

FIG. 4. Other embodiments of the present invention that comprise different proportions of neutral elements and additive primary color filter elements (red, green, and blue).

FIG. 5. Some other embodiments of the present invention that comprise subtractive primary color filters, cyan, magenta, yellow, and green.

FIG. 6. Other embodiments of the present invention that every other color filter block shifts either horizontally, vertically, or obliquely to ensure there are color filter elements in as many rows and columns as possible.

### DETAILED DESCRIPTION OF THE INVENTION

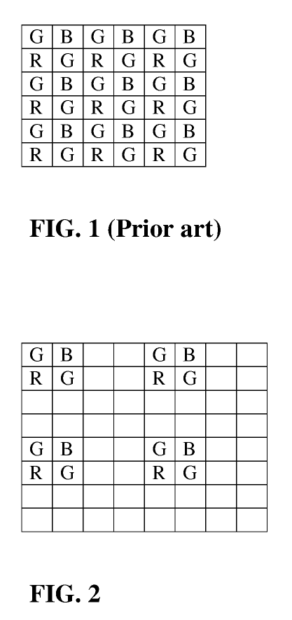

The present invention is a device and method that addresses certain disadvantages of prior art for digital imaging devices that use a color filter array (CFA). FIG. 1 shows the CFA pattern disclosed in U.S. Pat. No. 3,971,065 by Bayer. Unlike devices employing the Bayer pattern, the present invention collects and calculates real luminance and real chrominance information separately. Unlike the inventions disclosed in U.S. Pat. Nos. 5,323,233 and 5,914,749, the present invention is directed to sampling luminance information with a majority (>50%) of image sensor elements, and to sampling chrominance information with a minority of image sensor elements.

The benefit of providing neutral elements between color elements is several-fold. It enhances the signal to noise ratio that is addressed in Bawolek et al.'s patent (U.S. Pat. No. 5,914,749) and Yamagami, et al.'s patent (U.S. Pat. No. 5,323,233) so that imaging apparatus with high light sensitivity can be made by adopting the invention. The present invention can also yield higher image resolution than U.S. Pat. Nos. 5,323,233, 5,914,749, 6,476,865B1 and 6,714,243B1.

Referring to FIG. 2, one CFA embodiment of the present invention is where neutral elements are inserted between color elements as represented by the blank cells. In this embodiment 75% of the elements of the CFA are neutral elements, which can be neutral density filters or completely transparent ones, and the remaining 25% of the elements are color filter elements.

The imaging sensor elements beneath the neutral filter elements directly detect luminance, working like those in black-and-white cameras. From these pixels, full-frame gray scale images can be acquired by means of interpolation. A portion of the data matrix acquired with the embodiment is shown as follows, in which the four missing luminance values (X1 to X4) need to be calculated using known values from peripheral pixels.

L11 L12 L13 L14

L21 X1 X2 L24

L31 X3 X4 L34

L41 L42 L43 L44

A simple interpolation method to estimate the luminance values at pixels of color filter elements is the linear interpolation.

X1=(L21+(L24−L21)/3+L12+(L42−L12)/3)/2

X2=(L21+(L24−L21)*2/3+L13+(L43−L13)/3)/2

X3=(L31+(L34−L31)/3+L12+(L42−L12)*2/3)/2

X4=(L31+(L34−L31)*2/3+L13+(L43−L13)*2/3)/2

In the CFA as shown in FIG. 2, red, green, and blue color filter elements are arranged in a repeating block fashion. Each block is the same as the repeating 2-by-2 pattern in Bayer's CFA, i.e. two green filters in diagonal cells, and one red and one blue filter in an opposing diagonal direction. From these color filter elements, color images can be obtained by means of demosaic interpolation. A simple approach can be to first piece color filter blocks together to form a regular Bayer pattern, and then to use existing demosaic algorithms to calculate full color images. Examples of such algorithms and interpolation means are disclosed by Adams Jr. et al. in U.S. Pat. No. 5,652,621 and in K. Hirakawa and T. W. Parks, “Adaptive homogeneity-directed demosaicing algorithm”, IEEE Transactions on Image Processing, 14(3), pp. 360-369, 2005

The sizes of generated color images are normally smaller than those of the gray images mentioned above, but they can be easily resized to the same dimension. To combine the color images and the gray scale images, the color images, which are typically in RGB color space, it is preferable to transform the color images into a luminance-chrominance space, e.g. CIE 1976 Lab, YIQ, and HSB (hue-saturation-brightness). Luminance-chrominance color models are one type of model that specifically provide values of lightness to describe colors, unlike the tri-stimuli color models such as Red-Green-Blue (RGB) or Cyan-Magenta-Yellow (CMY). In the luminance-chrominance space, the luminance components (e.g. L component of Lab) of the color images are replaced by the gray scale images to result in new color images. Finally, they can be transformed to desired color spaces, e.g. RGB, and output.

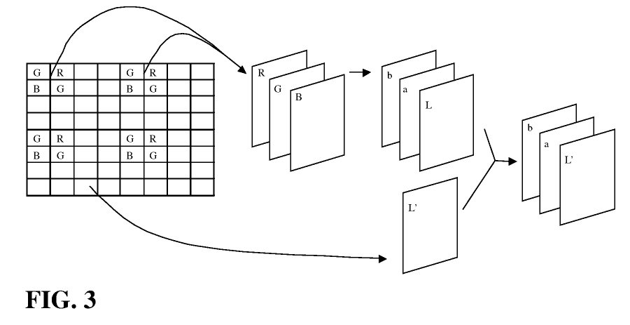

FIG. 3 schematically illustrates the process of the image formation described above, where panel L′ represents the gray scale images acquired from neutral elements, multiple panels RGB represent the color images acquired from color filter elements, multiple panels Lab represent the color images in luminance-chrominance spaces, and multiple panels L′ab represent the output color images. This process can be applied to all the embodiments of the present invention as well as the embodiments of other inventions comprising neutral elements.

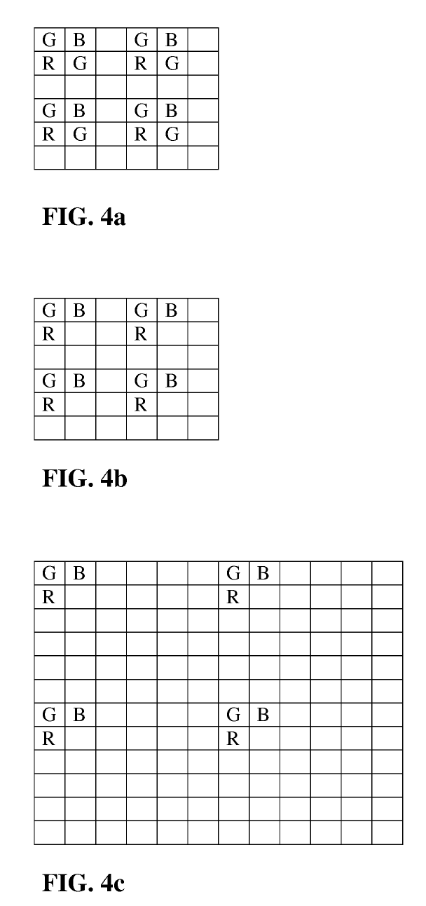

FIG. 4 illustrates some other embodiments of the present invention that comprise different proportions of neutral elements. Neutral elements make up 55% (5/9) of the CFA in FIG. 4a, 67% (6/9) in FIG. 4b, and 92% (33/36) in FIG. 4c. The remaining elements in the CFAs shown in FIG. 4 are red, green and blue color filters whose spectrum characteristics are the same as those used in the Bayer CFA.

Because the luminance and chrominance are sampled and calculated separately, the sampling rate of luminance between 55% and 92% can be easily designed to suit different applications by configuring the repeating period of color filter block. For example, the repeating period is 3 pixels in FIG. 4b, 4 pixels in FIG. 2, and 6 pixels in FIG. 4c both horizontally and vertically. To achieve different chrominance sampling rates for horizontal and vertical directions, the repeating periods in the two directions can be different. The higher the luminance sampling rate is, the higher light sensitivity, but the worse the color distortion. CFA with more than 92% of luminance sampling rate will result in too coarse a sampling of chrominance to be useful.

Not only by repeating the period, the sampling rate of luminance can be varied also by configuring whether each color filter block includes three or four color filter elements. For instance, in CFAs shown in FIG. 2 and FIG. 4a, each color filter block includes four color filter elements: two green filters in diagonal cells, and one red and one blue filters in an opposing diagonal direction. In CFAs shown in FIG. 4b and FIG. 4c, each color filter block includes three color filter elements. For these CFAs, a simple demosaicing method can be employed; namely, a nearest neighbor algorithm. This method computes the values for each “color” pixel using the three values from the surrounding pixels in the same one block.

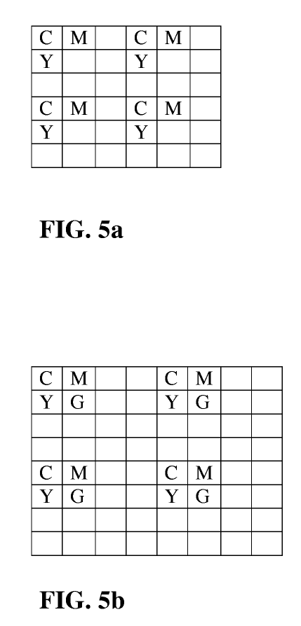

FIG. 5 illustrates some other embodiments of the present invention that comprise subtractive primary color filters, cyan (C), magenta (M), and yellow (Y). The configuration of neutral elements of these CFAs is the same as that for CFAs comprising RGB filters, but the color filters are mainly CMY instead. FIG. 5 shows two CFAs in which the luminance sampling rates are 67% (6/9) as in FIG. 5a and 75% (12/16) as in FIG. 5b, respectively. As in the RGB type of aforementioned CFAs, the CMY type of CFAs of the present invention can be configured with different luminance sampling rates ranging from 56% to 92%. CFAs comprised of CMY filters have been used in some digital cameras, for example, the Kodak DCS620X. To improve color fidelity, a green filter element can be used in each color filter block, as shown in FIG. 5b.

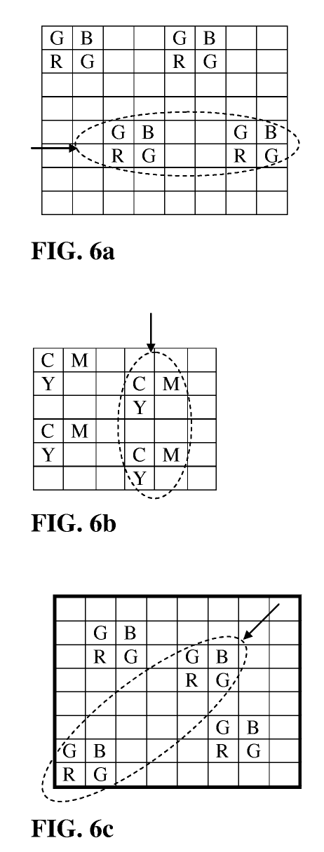

FIG. 6 illustrates some other embodiments of the present invention that every other color filter block (circled by dashed lines) shifts either horizontally, vertically, or obliquely a certain amount to ensure there are color filter elements in as many rows and columns as possible. For instance, in the CFA shown in FIG. 2, every third and fourth rows and every third and fourth columns are all neutral elements. Obtaining chrominance information in these rows and columns may be favorable. FIG. 6a illustrates a variation of the CFA shown in FIG. 2, in which the color filter block in every other fifth and sixth rows shift two elements to the right so that there are color filter elements in every column of the CFA. Similarly, FIG. 6b illustrates a variation of the CFA shown in FIG. 5a, in which the color filter block in every other fourth and fifth columns shift one element down so that there are color filter elements in every row and column of the CFA. FIG. 6c, illustrates a variation of the CFA shown in FIG. 2, in which the filter blocks circled by dashed line shift obliquely to south-west. The shift configuration can be applied to all the embodiments of the present invention.

A number of embodiments of the invention have been described. Nevertheless, it shall be understood that various modifications may be made without departing from the spirit and scope of the invention. Accordingly, other embodiments are within the scope of the following claims.

I claim:

1. An image sensing device having an array of image sensors and a color filter structure disposed in relation to the image sensors, the filter structure comprised of
a plurality of neutral filter elements for passing a luminance component of an image; and color filter elements for passing color components of the image,
wherein said color filter array has 55% to 92% of its elements comprised of neutral filter elements and the remaining elements comprising at least three types of color filter elements for passing the color components of the image.

2. The color filter array claimed in claim 1, wherein the color filter elements occur in repeating block patterns such that each block comprises at least three types of color filter elements.

3. A color filter array according to claim 1, wherein said three color components comprise red, green, and blue components of the image, respectively.

4. A color filter array according to claim 1, wherein said three color components comprise cyan, yellow, and magenta components of the image, respectively.

5. A color filter array according to claim 1, wherein a fourth type of color filter elements for passing green component of the image are used along with cyan, yellow and magenta elements.

6. A color filter array according to claim 2, wherein said blocks may be shifted by one or more columns from adjacent blocks.

7. A color filter array according to claim 2, wherein said blocks may be shifted by one or more rows from adjacent blocks.

8. The image sensing device of claim 1 further comprising electronic components for sampling and storing values from photo sensitive elements of an array for conversion to digital form and enabling subsequent calculations to be made for approximating luminance and chrominance values.

9. The image sensing device of claim 8 further comprising a means for outputting such luminance and chrominance values in a form compatible with prevailing imaging standards.

10. The image sensing device of claim 8 is incorporated into digital imaging devices such as a still image camera, video camera, scanner or the like.

11. A method of forming a color image, comprising the steps of:
a) providing an image sensing device having an array of light-sensitive elements in juxtaposition with a color filter array having varying filter properties, which includes a plurality of elements sensitive to a spectral region corresponding to luminance; and remaining elements sensitive to color components of the image;
b) employing the image sensing device to produce a sampled image;
c) calculating the missing luminance pixel values in the sampled image to generate a complete gray scale image;
d) calculating the missing color pixel values in the sampled image to generate a full color image having red, green and blue pixel values; and
e) resizing the color image to be the same size of the gray scale image.

12. The method of claim 11 further comprising a means for transforming the color image to a luminance-chrominance color space, preferably CIE Lab;
replacing the luminance component of the color image with the gray scale image; and
transforming the color image to a desired color space if needed.

13. The method of claim 11, wherein the color filter elements occur in blocks of repeating patterns such that each block comprises at least three types of color filter elements.

14. The method claimed in claim 11, wherein the calculating and resizing steps are performed in a camera comprising the image sensing device.

15. An image sensing device having an array of image sensors in juxtaposition with a color filter array having varying filter properties which is integrated into a semi-conductor device that is connected to a second semiconductor device that carries out certain computations and outputs to viewers, storage devices, and the like wherein the filter array is further comprised of neutral filter elements sensitive to a spectral region corresponding to luminance of light, and blocks of filter elements that selectively pass at least three different spectral qualities of light sufficient to reconstruct full color images.

16. The device of claim 15 wherein the three different spectral qualities represent bandwidths suitable for red, blue and green.

17. The device of claim 15 wherein the three different spectral qualities represent outputs for cyan, magenta and yellow.

18. The device of claim 15 wherein certain computations include algorithms for interpolation of colors based upon values at a particular pixel being averaged with values from nearest neighbors pixels.
